(19) United States
(12) Patent Application Publication
(10) Pub. No.: US 2021/0327165 A1
(43) Pub. Date: Oct. 21, 2021

(54) VEHICLE MALFUNCTION PREDICTION SYSTEM, MONITORING DEVICE, VEHICLE MALFUNCTION PREDICTION METHOD, AND VEHICLE MALFUNCTION PREDICTION PROGRAM

(71) Applicant: Sumitomo Electric Industries, Ltd., Osaka (JP)

(72) Inventors: Guiming DAI, Osaka (JP); Kenichi HATANAKA, Osaka (JP); Yuna OKINA, Osaka (JP); Toshiaki KAKII, Osaka (JP); Katsushi MIURA, Osaka (JP)

(73) Assignee: Sumitomo Electric Industries, Ltd., Osaka (JP)

(21) Appl. No.: 17/295,039

(22) PCT Filed: Sep. 27, 2019
(86) PCT No.: PCT/JP2019/038233

§ 371 Date: May 19, 2021

(30) Foreign Application Priority Data
Nov. 27, 2018 (JP) 2018-221261

(51) Int. Cl. G07C 5/00; G06N 20/00; G06N 5/04; G07C 5/08

(52) U.S. Cl. CPC G07C 5/008; G07C 5/085; G06N 5/04; G06N 20/00

(57) ABSTRACT

A vehicle malfunction prediction system includes: one or more monitoring devices, each monitoring device obtaining from a functional unit in a vehicle in which the monitoring device is mounted, functional-unit information indicating a result of measurement related to the vehicle; and a management device. The monitoring device transmits the obtained functional-unit information to the management device via an external network. The management device creates a learning model based on machine learning on the basis of a plurality of pieces of functional-unit information received from the one or more monitoring devices and transmits the created learning model to the one or more monitoring devices. Each monitoring device predicts a malfunction in the vehicle in which the monitoring device is mounted on the basis of new functional-unit information from the functional unit in the vehicle in which the monitoring device is mounted and based on the learning model from the management device.

### TECHNICAL FIELD

The present invention relates to a vehicle malfunction prediction system, a monitoring device, a vehicle malfunction prediction method, and a vehicle malfunction prediction program.

The present application claims priority from Japanese Patent Application No. 2018-221261 filed on Nov. 27, 2018, the entire content of which is incorporated herein by reference.

### BACKGROUND ART

In “Fujitsu Defends In-Vehicle Networks with New Technology to Detect Cyberattacks” [online] [searched on Nov. 19, 2018], Internet <URL: http://pr.fujitsu.com/jp/news/2018/01/24-1.html> (Non Patent Literature 1), a technique for detecting cyberattacks on in-vehicle networks by learning the reception cycle of messages conforming to the CAN (Controller Area Network) (registered trademark) standard and using the difference between the number of received messages corresponding to the learned cycle and the number of actually received messages is disclosed.

### CITATION LIST

### Non Patent Literature

NPL 1: “Fujitsu Defends In-Vehicle Networks with New Technology to Detect Cyberattacks” [online] [searched on Nov. 19, 2018], Internet <URL: http://pr.fujitsu.com/jp/news/2018/01/24-1.html>

### SUMMARY OF INVENTION

(1) A vehicle malfunction prediction system according to the present disclosure includes: one or more monitoring devices, each monitoring device among the one or more monitoring devices obtaining from a functional unit in a vehicle in which the monitoring device is mounted, functional-unit information indicating a result of measurement related to the vehicle; and a management device. The monitoring device transmits the obtained functional-unit information to the management device via an external network. The management device creates a learning model based on machine learning on the basis of a plurality of pieces of functional-unit information received from the one or more monitoring devices and transmits the created learning model to the one or more monitoring devices. Each monitoring device predicts a malfunction in the vehicle in which the monitoring device is mounted on the basis of new functional-unit information obtained from the functional unit in the vehicle in which the monitoring device is mounted and on the basis of the learning model received from the management device.

(7) A monitoring device according to the present disclosure includes: an obtaining unit that obtains from a functional unit in a vehicle in which the monitoring device is mounted, functional-unit information indicating a result of measurement related to the vehicle; a transmission unit that transmits the functional-unit information obtained by the obtaining unit to a management device; and a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.

(8) A vehicle malfunction prediction method according to the present disclosure is a vehicle malfunction prediction method for a vehicle malfunction prediction system that includes one or more monitoring devices and a management device. The vehicle malfunction prediction method includes: a step of obtaining, by each monitoring device among the one or more monitoring devices, from a functional unit in a vehicle in which the monitoring device is mounted, functional-unit information indicating a result of measurement related to the vehicle; a step of transmitting, by the monitoring device, the obtained functional-unit information to the management device via an external network; a step of creating, by the management device, a learning model based on machine learning on the basis of a plurality of pieces of functional-unit information received from the one or more monitoring devices; a step of transmitting, by the management device, the created learning model to the one or more monitoring devices; and a step of predicting, by each monitoring device, a malfunction in the vehicle in which the monitoring device is mounted on the basis of new functional-unit information obtained from the functional unit in the vehicle in which the monitoring device is mounted and on the basis of the learning model received from the management device.

(9) A vehicle malfunction prediction method according to the present disclosure is a vehicle malfunction prediction method for a monitoring device. The vehicle malfunction prediction method includes: a step of obtaining from a functional unit in a vehicle in which the monitoring device is mounted, functional-unit information indicating a result of measurement related to the vehicle; a step of transmitting the obtained functional-unit information to a management device; and a step of predicting a malfunction in the vehicle on the basis of a learning model based on machine learning, the learning model being created by the management device on the basis of a plurality of pieces of functional-unit information received from one or more monitoring devices, and on the basis of obtained new functional-unit information.

(10) A vehicle malfunction prediction program according to the present disclosure is a vehicle malfunction prediction program to be used in a monitoring device. The vehicle malfunction prediction program causes a computer to function as: an obtaining unit that obtains from a functional unit in a vehicle in which the monitoring device is mounted, functional-unit information indicating a result of measurement related to the vehicle; a transmission unit that transmits the functional-unit information obtained by the obtaining unit to a management device; and a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.

An aspect of the present disclosure can be implemented not only as the vehicle malfunction prediction system including the above-described characteristic processing units but also as a program for causing a computer to perform the above-described characteristic processes. Further, an aspect of the present disclosure can be implemented as a semiconductor integrated circuit that implements the vehicle malfunction prediction system in part or in whole.

An aspect of the present disclosure can be implemented not only as the monitoring device including the above-described characteristic processing units but also as a semiconductor integrated circuit that implements the monitoring device in part or in whole.

### BRIEF DESCRIPTION OF DRAWINGS

FIG. 1 is a diagram illustrating a configuration of a vehicle malfunction prediction system according to an embodiment of the present invention.

FIG. 2 is a diagram illustrating a configuration of a monitoring device according to the embodiment of the present invention.

FIG. 3 is a diagram illustrating a configuration of a management device according to the embodiment of the present invention.

FIG. 4 is a sequence chart illustrating an example flow of operations of devices related to a prediction process in the vehicle malfunction prediction system according to the embodiment of the present invention.

FIG. 5 is a sequence chart illustrating a flow of operations of devices related to transmission of condition information in the vehicle malfunction prediction system according to the embodiment of the present invention.

### DESCRIPTION OF EMBODIMENTS

Techniques for detecting abnormalities occurring in in-vehicle networks have been developed to date.

### Problems to be Solved by Present Disclosure

The technique described in Non Patent Literature 1 can detect abnormalities occurring in vehicles but has difficulty in predicting in advance abnormalities occurring in vehicles.

The present disclosure has been made to address the above-described problem, and an object thereof is to provide a vehicle malfunction prediction system, a monitoring device, a vehicle malfunction prediction method, and a vehicle malfunction prediction program that can predict malfunctions in vehicles with high accuracy by using a device having a simple configuration.

### Advantageous Effects of Present Disclosure

With the present disclosure, malfunctions in vehicles can be predicted with high accuracy by using a device having a simple configuration.

### DESCRIPTION OF EMBODIMENTS OF PRESENT INVENTION

First, the contents of embodiments of the present invention are listed and described.

(1) A vehicle malfunction prediction system according to an embodiment of the present invention includes: one or more monitoring devices, each monitoring device among the one or more monitoring devices obtaining from a functional unit in a vehicle in which the monitoring device is mounted, functional-unit information indicating a result of measurement related to the vehicle; and a management device. The monitoring device transmits the obtained functional-unit information to the management device via an external network. The management device creates a learning model based on machine learning on the basis of a plurality of pieces of functional-unit information received from the one or more monitoring devices and transmits the created learning model to the one or more monitoring devices. Each monitoring device predicts a malfunction in the vehicle in which the monitoring device is mounted on the basis of new functional-unit information obtained from the functional unit in the vehicle in which the monitoring device is mounted and on the basis of the learning model received from the management device.

As described above, with the configuration in which the monitoring device predicts a malfunction in the vehicle on the basis of functional-unit information and a learning model, the user can grasp in advance a malfunction that may occur in the vehicle. The management device creates a learning model, and therefore, the configuration of the monitoring device can be made simple. Further, in a case where the management device creates a learning model by using functional-unit information from a plurality of monitoring devices, the management device can create a learning model of higher accuracy by using the results of measurement in a plurality of vehicles. Accordingly, a malfunction in the vehicle can be predicted with high accuracy by using a device having a simple configuration.

(2) Preferably, the monitoring device transmits a result of prediction of a malfunction in the vehicle in which the monitoring device is mounted to the external network.

With the above-described configuration, in a case where, for example, the monitoring device transmits the result of prediction of a malfunction in the vehicle to the management device, the management device can create a learning model of higher accuracy using the result of prediction by the monitoring device.

(3) Preferably, the monitoring device and the management device transmit and receive information via a terminal device in the vehicle in which the monitoring device is mounted.

With the above-described configuration, the monitoring device need not have a function of communicating with the management device via the external network, and therefore, the configuration of the monitoring device can be further made simple.

(4) Preferably, the vehicle malfunction prediction system further includes an external device that is provided on the external network and sends a notification of a result of prediction, by the monitoring device, of a malfunction in the vehicle to a terminal device.

With the above-described configuration, a highly convenient system in which a notification of the result of prediction by the monitoring device can be sent to the user owning the terminal device can be implemented.

(5) Preferably, the external device selectively sends the notification of the result of prediction to a specific terminal device.

With the above-described configuration, for example, a notification of the result of prediction by the monitoring device can be selectively sent to a user who has made in advance a contract with the administrator of the external device, and the administrator can be, for example, paid for the service of sending the notification of the result of prediction.

(6) Preferably, the monitoring device receives a transmission request for condition information that indicates a condition of the vehicle in which the monitoring device is mounted and sends a notification of a result of prediction of a malfunction in the vehicle to a transmission source that has transmitted the transmission request.

With the above-described configuration, the user can grasp the conditions of the vehicle at a desired timing regardless of the result of prediction, by the monitoring device, of a malfunction in the vehicle.

(7) A monitoring device according to an embodiment of the present invention includes: an obtaining unit that obtains from a functional unit in a vehicle in which the monitoring device is mounted, functional-unit information indicating a result of measurement related to the vehicle; a transmission unit that transmits the functional-unit information obtained by the obtaining unit to a management device; and a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.

As described above, with the configuration in which the monitoring device predicts a malfunction in the vehicle on the basis of functional-unit information and a learning model, the user can grasp in advance a malfunction that may occur in the vehicle. The management device creates a learning model, and therefore, the configuration of the monitoring device can be made simple. Further, in a case where the management device creates a learning model by using functional-unit information from a plurality of monitoring devices, the management device can create a learning model of higher accuracy by using the results of measurement in a plurality of vehicles. Accordingly, a malfunction in the vehicle can be predicted with high accuracy by using a device having a simple configuration.

(8) A vehicle malfunction prediction method according to an embodiment of the present invention is a vehicle malfunction prediction method for a vehicle malfunction prediction system that includes one or more monitoring devices and a management device. The vehicle malfunction prediction method includes: a step of obtaining, by each monitoring device among the one or more monitoring devices, from a functional unit in a vehicle in which the monitoring device is mounted, functional-unit information indicating a result of measurement related to the vehicle; a step of transmitting, by the monitoring device, the obtained functional-unit information to the management device via an external network; a step of creating, by the management device, a learning model based on machine learning on the basis of a plurality of pieces of functional-unit information received from the one or more monitoring devices; a step of transmitting, by the management device, the created learning model to the one or more monitoring devices; and a step of predicting, by each monitoring device, a malfunction in the vehicle in which the monitoring device is mounted on the basis of new functional-unit information obtained from the functional unit in the vehicle in which the monitoring device is mounted and on the basis of the learning model received from the management device.

As described above, with the method in which the monitoring device predicts a malfunction in the vehicle on the basis of functional-unit information and a learning model, the user can grasp in advance a malfunction that may occur in the vehicle. The management device creates a learning model, and therefore, the configuration of the monitoring device can be made simple. Further, in a case where the management device creates a learning model by using functional-unit information from a plurality of monitoring devices, the management device can create a learning model of higher accuracy by using the results of measurement in a plurality of vehicles. Accordingly, a malfunction in the vehicle can be predicted with high accuracy by using a device having a simple configuration.

(9) A vehicle malfunction prediction method according to an embodiment of the present invention is a vehicle malfunction prediction method for a monitoring device. The vehicle malfunction prediction method includes: a step of obtaining from a functional unit in a vehicle in which the monitoring device is mounted, functional-unit information indicating a result of measurement related to the vehicle; a step of transmitting the obtained functional-unit information to a management device; and a step of predicting a malfunction in the vehicle on the basis of a learning model based on machine learning, the learning model being created by the management device on the basis of a plurality of pieces of functional-unit information received from one or more monitoring devices, and on the basis of obtained new functional-unit information.

As described above, with the method in which the monitoring device predicts a malfunction in the vehicle on the basis of functional-unit information and a learning model, the user can grasp in advance a malfunction that may occur in the vehicle. The management device creates a learning model, and therefore, the configuration of the monitoring device can be made simple. Further, in a case where the management device creates a learning model by using functional-unit information from a plurality of monitoring devices, the management device can create a learning model of higher accuracy by using the results of measurement in a plurality of vehicles. Accordingly, a malfunction in the vehicle can be predicted with high accuracy by using a device having a simple configuration.

(10) A vehicle malfunction prediction program according to an embodiment of the present invention is a vehicle malfunction prediction program to be used in a monitoring device. The vehicle malfunction prediction program causes a computer to function as: an obtaining unit that obtains from a functional unit in a vehicle in which the monitoring device is mounted, functional-unit information indicating a result of measurement related to the vehicle; a transmission unit that transmits the functional-unit information obtained by the obtaining unit to a management device; and a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.

As described above, with the configuration in which the monitoring device predicts a malfunction in the vehicle on the basis of functional-unit information and a learning model, the user can grasp in advance a malfunction that may occur in the vehicle. The management device creates a learning model, and therefore, the configuration of the monitoring device can be made simple. Further, in a case where the management device creates a learning model by using functional-unit information from a plurality of monitoring devices, the management device can create a learning model of higher accuracy by using the results of measurement in a plurality of vehicles. Accordingly, a malfunction in the vehicle can be predicted with high accuracy by using a device having a simple configuration.

Hereinafter, embodiments of the present invention will be described with reference to the drawings. Note that identical or equivalent parts in the drawings are assigned the same reference numeral, and a description thereof is not repeatedly given. Further, at least some of the embodiments described below may be combined as desired.

<Configuration and Basic Operations>

[Overview of Vehicle Malfunction Prediction System]

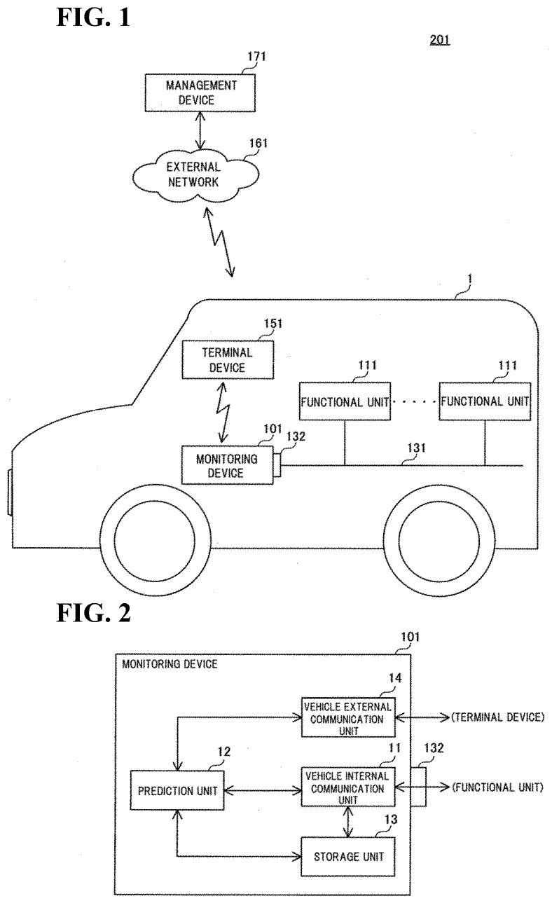

FIG. 1 is a diagram illustrating a configuration of a vehicle malfunction prediction system according to an embodiment of the present invention.

With reference to FIG. 1, a vehicle malfunction prediction system 201 includes a monitoring device 101, one or more functional units 111, a terminal device 151, and a management device (external device) 171. The monitoring device 101, the functional units 111, and the terminal device 151 are mounted in a vehicle 1.

Note that the vehicle malfunction prediction system 201 may include a plurality of monitoring devices 101 and a plurality of terminal devices 151. In this case, the plurality of monitoring devices 101 are mounted in a plurality of vehicles 1 respectively, and the plurality of terminal devices 151 are mounted in the plurality of vehicles 1 respectively.

The terminal device 151 wirelessly communicates with the management device 171 via an external network 161, which is a network outside the vehicle 1, in accordance with, for example, the LTE (Long Term Evolution) or 5G (5th Generation) standard. The terminal device 151 wirelessly communicates with the monitoring device 101 in accordance with a standard, such as Wi-Fi (registered trademark) or Bluetooth (registered trademark).

The monitoring device 101 and the management device 171, for example, transmit and receive information via the terminal device 151 in the vehicle 1 corresponding to the monitoring device 101. That is, the monitoring device 101 and the management device 171 transmit and receive information via the terminal device 151 in the vehicle 1 in which the monitoring device 101 is mounted.

The functional units 111 are, for example, an autonomous driving ECU (electronic control unit), a temperature sensor, an engine ECU, a navigation device, a camera, and so on. Each functional unit 111 is connected to the monitoring device 101 via, for example, a CAN bus 131 conforming to the CAN standard and a connector 132. The connector 132 is a connector conforming to, for example, the OBD (On-Board Diagnostics) II standard.

The monitoring device 101 and each functional unit 111 communicate with each other via the CAN bus 131. Between the monitoring device 101 and each functional unit 111, various types of information are exchanged by using CAN frames, which are communication frames conforming to the CAN standard. Note that the monitoring device 101 and each functional unit 111 may be configured to communicate with each other by using wireless communication conforming to, for example, Wi-Fi or Bluetooth.

Each functional unit 111 creates functional-unit information that indicates the result of measurement including the measurement value, the measurement timing, and so on related to the vehicle 1, and transmits the created functional-unit information to the monitoring device 101. Specifically, in a case where one of the functional units 111 is, for example, a temperature sensor, the functional unit 111 transmits functional-unit information indicating, for example, the result of measurement of the temperature inside the vehicle 1. In a case where one of the functional units 111 is an engine ECU, the functional unit 111 transmits functional-unit information indicating, for example, the result of measurement of the rotation speed of the engine of the vehicle 1.

The monitoring device 101 obtains functional-unit information from each functional unit 111 and performs a prediction process of predicting a malfunction in the vehicle 1 on the basis of the obtained functional-unit information and a learning model retained by the monitoring device 101. More specifically, the monitoring device 101, for example, receives functional-unit information transmitted from each functional unit 111 and performs, on the basis of the waveform of a measurement value indicated by the functional-unit information, a prediction process in which the monitoring device 101 makes a diagnosis regarding the possibility of a malfunction occurring in the vehicle 1 and in a case where there is the possibility of a malfunction occurring in the vehicle 1, predicts, for example, the time when a malfunction is highly likely to occur.

Accordingly, the monitoring device 101 can predict that, for example, a malfunction is highly likely to occur in the vehicle 1 in three months.

The monitoring device 101 transmits functional-unit information from each functional unit 111 in the vehicle 1 corresponding to the monitoring device 101 to the management device 171 via the external network 161. That is, the monitoring device 101 transmits functional-unit information from each functional unit 111 in the vehicle 1 in which the monitoring device 101 is mounted to the management device 171 via the external network 161. More specifically, the monitoring device 101 transmits a plurality of pieces of functional-unit information used in a prediction process to the management device 171 via the terminal device 151 and the external network 161. Further, the monitoring device 101 transmits the result of the prediction process to the management device 171 via the external network 161.

Specifically, the monitoring device 101, for example, creates post-process information that includes a plurality of pieces of functional-unit information used in a prediction process and the result of the prediction process, and transmits the created post-process information to the management device 171 via the terminal device 151 and the external network 161.

Note that as the prediction process, the monitoring device 101 may predict, for example, the probability of a malfunction occurring in the vehicle 1 instead of or in addition to the possibility of a malfunction occurring in the vehicle 1 and, in a case where there is the possibility of a malfunction occurring in the vehicle 1, the time when a malfunction is highly likely to occur.

When receiving the post-process information transmitted from the monitoring device 101, the terminal device 151 transmits the post-process information to the management device 171.

The management device 171 receives the post-process information transmitted from the monitoring device 101 via the terminal device 151 and the external network 161 and creates a learning model based on machine learning on the basis of the received post-process information.

More specifically, the management device 171 receives a plurality of pieces of post-process information transmitted from one or more monitoring devices 101 and creates a learning model in accordance with a deep learning method, which is an example of machine learning, on the basis of the plurality of received pieces of post-process information.

The management device 171 transmits learning model information indicating the created learning model to each monitoring device 101 via the external network 161 and the terminal device 151.

When receiving the learning model information transmitted from the management device 171 via the external network 161, the terminal device 151 transmits the learning model information to the monitoring device 101.

The monitoring device 101 receives the learning model information transmitted from the terminal device 151 and retains the learning model indicated by the received learning model information. Note that in a case where the monitoring device 101 already retains a learning model, the monitoring device 101 updates the retained learning model. After updating the learning model, the monitoring device 101 performs the prediction process described above by using new functional-unit information obtained from each functional unit 111 and the latest learning model.

Note that each functional unit 111 may be configured to make a diagnosis as to whether a malfunction is occurring in the vehicle 1. In this case, for example, the functional unit 111 measures the current flowing through the CAN bus 131 and the voltage of the CAN bus 131 and makes a diagnosis as to whether a malfunction is occurring in the functional unit 111 or in another device connected to the functional unit 111 on the basis of the result of measurement. The functional unit 111 transmits functional-unit information indicating the result of measurement and the result of diagnosis to the monitoring device 101.

The monitoring device 101 receives a plurality of pieces of functional-unit information transmitted from the functional units 111 and performs a prediction process on the basis of the plurality of received pieces of functional-unit information and the learning model by, for example, analyzing the waveforms of the measurement values obtained by each functional unit 111, that is, time-series changes in the current and in the voltage measured by the functional unit 111.

The monitoring device 101, for example, transmits post-process information that includes the plurality of pieces of functional-unit information used in the prediction process and the result of the prediction process to the management device 171 via the terminal device 151 and the external network 161.

The management device 171 receives the post-process information transmitted from the monitoring device 101 via the terminal device 151 and the external network 161 and creates a learning model on the basis of the received post-process information. At this time, in addition to the results of measurement indicated by the plurality of pieces of functional-unit information, the management device 171 can also use the results of diagnosis corresponding to the respective results of measurement and indicated by the plurality of pieces of functional-unit information to create a learning model of higher accuracy.

The management device 171 transmits learning model information indicating the created learning model to the monitoring device 101 via the external network 161 and the terminal device 151.

The monitoring device 101 receives the learning model information transmitted from the management device 171 via the external network 161 and the terminal device 151 and performs a prediction process on the basis of the learning model indicated by the received learning model information. As described above, a learning model of higher accuracy is created by the management device 171, and therefore, the accuracy of the prediction process by the monitoring device 101 can be further improved.

Even in a case where, for example, functional-unit information from any of the functional units 111 indicates the result of diagnosis showing that no malfunction is currently occurring in the vehicle 1, a prediction result showing that, for example, a malfunction is highly likely to occur in the vehicle 1 in three months can be obtained by the monitoring device 101 performing a prediction process.

[Monitoring Device]

(Prediction Process for Vehicle)

FIG. 2 is a diagram illustrating a configuration of the monitoring device according to the embodiment of the present invention.

With reference to FIG. 2, the monitoring device 101 includes a vehicle internal communication unit (obtaining unit) 11, a prediction unit 12, a storage unit 13, and a vehicle external communication unit (transmission unit) 14.

The prediction unit 12, for example, transmits a functional-unit information request for requesting functional-unit information to the functional units 111 via the vehicle internal communication unit 11 regularly or irregularly. The vehicle internal communication unit 11 receives functional-unit information transmitted from each functional unit 111 and saves the received functional-unit information in the storage unit 13. The storage unit 13 is, for example, a nonvolatile memory.

The prediction unit 12 performs a prediction process for the vehicle 1 on the basis of the functional-unit information obtained by the vehicle internal communication unit 11, that is, the functional-unit information saved in the storage unit 13, and on the basis of a learning model created by the management device 171.

More specifically, the prediction unit 12, for example, performs for a plurality of pieces of functional-unit information saved in the storage unit 13, preprocessing, such as an analysis of measurement values indicated by the pieces of functional-unit information, reduction of noise and so on, a time synchronization process, and complementing of missing data, for each functional unit 111. Further, the prediction unit 12, for example, performs, for example, a vectorization process for putting the plurality of pieces of functional-unit information subjected to preprocessing in time-series order on the basis of the measurement timings indicated by the plurality of pieces of functional-unit information, for each functional unit 111.

The prediction unit 12 uses the plurality of pieces of functional-unit information subjected to the preprocessing, the vectorization process, and so on and the learning model saved in the storage unit 13 to analyze time-series changes in the measurement values, thereby performing a prediction process.

The prediction unit 12 creates post-process information that includes the plurality of pieces of functional-unit information used in the prediction process and the result of the prediction process and outputs the created post-process information to the vehicle external communication unit 14. The prediction unit 12 saves the post-process information in the storage unit 13.

The vehicle external communication unit 14 receives the post-process information output from the prediction unit 12 and transmits the post-process information to the management device 171 via the terminal device 151 and the external network 161. Note that the vehicle external communication unit 14 may be configured to transmit the post-process information to the management device 171 via the external network 161 without the terminal device 151.

Further, the vehicle external communication unit 14 receives learning model information transmitted from the management device 171 via the external network 161 and the terminal device 151 and saves a learning model indicated by the received learning model information in the storage unit 13.

Note that the prediction unit 12 may be configured to transmit post-process information that includes the results of measurement but does not include the result of a prediction process performed by the prediction unit 12 to the management device 171 via the vehicle external communication unit 14, the terminal device 151, and the external network 161.

Further, the prediction unit 12 may transmit to a device on the external network 161 other than the management device 171 the result of the prediction process via the vehicle external communication unit 14. For example, the prediction unit 12 may send a notification of the result of the prediction process to a terminal device provided outside the vehicle 1.

(Notification of Vehicle Conditions)

The terminal device 151 illustrated in FIG. 1 transmits a condition information request, which is a request for transmitting condition information indicating the conditions of the vehicle 1, to the monitoring device 101 in accordance with, for example, a user operation. The monitoring device 101 receives the condition information request from the terminal device 151 and sends a notification of the result of prediction of a malfunction in the vehicle 1 to the terminal device 151.

The vehicle external communication unit 14 in the monitoring device 101 receives the condition information request transmitted from the terminal device 151 and outputs the received condition information request to the prediction unit 12.

The prediction unit 12 receives the condition information request output from the vehicle external communication unit 14 and, for example, refers to post-process information saved in the storage unit 13 to create condition information that indicates the result of a prediction process indicated by the latest post-process information. The prediction unit 12 outputs the created condition information to the vehicle external communication unit 14.

The vehicle external communication unit 14 receives the condition information output from the prediction unit 12 and transmits the condition information to the terminal device 151 that has transmitted the condition information request.

The terminal device 151 receives the condition information transmitted from the monitoring device 101 and, for example, displays the content of the received condition information on a screen of the terminal device 151.

Note that condition information may be transmitted to a terminal device different from the terminal device 151 and provided outside the vehicle 1.

Further, the monitoring device 101 may be configured not to create and transmit condition information.

[Management Device]

(Creation of Learning Model)

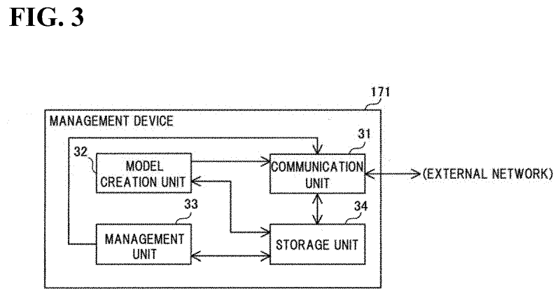

FIG. 3 is a diagram illustrating a configuration of the management device according to the embodiment of the present invention.

With reference to FIG. 3, the management device 171 includes a communication unit 31, a model creation unit 32, a management unit 33, and a storage unit 34.

The communication unit 31 receives a plurality of pieces of post-process information transmitted from one or more monitoring devices 101 via the external network 161 and saves the plurality of received pieces of post-process information in the storage unit 34. The storage unit 34 is, for example, a nonvolatile memory.

The model creation unit 32, for example, creates and updates a learning model regularly or irregularly on the basis of the plurality of pieces of post-process information saved in the storage unit 34.

The number of pieces of post-process information that can be used for a learning model, that is, the number of pieces of post-process information accumulated in the storage unit 34, increases as the time passes. Accordingly, the accuracy of a learning model created by the model creation unit 32 is highly likely to increase each time the learning model is updated.

The model creation unit 32, for example, transmits learning model information indicating the created or updated learning model to one or more terminal devices 151 via the communication unit 31 and the external network 161. Note that the learning model information may further indicate that creation or update of the learning model has been performed.

Each terminal device 151 receives the learning model information transmitted from the management device 171 via the external network 161 and transmits the learning model information to the monitoring device 101.

Note that one or more terminal devices 151 that transmit post-process information may be the same as one or more terminal devices 151 to which learning model information is transmitted, or one or more terminal devices 151 that transmit post-process information may be different, in part or in whole, from one or more terminal devices 151 to which learning model information is transmitted.

Further, the communication unit 31 may be configured to transmit learning model information to the monitoring device 101 via the external network 161 without the terminal device 151.

(Transmission of Warning Information)

The management device 171 sends a notification of the result of prediction, by the monitoring device 101, of a malfunction in the vehicle 1 to the terminal device 151.

Specifically, post-process information from the monitoring device 101 includes, for example, identification information of the monitoring device 101 that has transmitted the post-process information. On the basis of identification information included in each of the plurality of pieces of post-process information saved in the storage unit 34, the management unit 33 manages pieces of post-process information for each monitoring device 101 and selectively sends a notification of the result of diagnosis indicated by the latest piece of post-process information to a corresponding specific monitoring device 101.

More specifically, for example, identification information of the monitoring device 101 in the vehicle 1 of a user having a contract with an administrator (hereinafter also referred to as “contract monitoring device”) and identification information of the terminal device 151 corresponding to the contract monitoring device 101 are registered to the storage unit 34.

The management unit 33, for example, refers to post-process information saved in the storage unit 34 regularly or irregularly and in a case where post-process information that includes identification information of the contract monitoring device 101 indicates the possibility of a malfunction occurring in the vehicle 1 within a predetermined period of, for example, three months, transmits warning information indicating the content of the post-process information to the terminal device 151 corresponding to the contract monitoring device 101 via the communication unit 31. Note that the predetermined period can be set by the user.

When receiving the warning information transmitted from the management device 171 via the external network 161, the terminal device 151, for example, displays the content of the received warning information on a screen of the terminal device 151.

Note that warning information may be transmitted to a terminal device different from the terminal device 151 in the vehicle 1 and provided outside the vehicle 1. In this case, identification information of the terminal device other than the terminal device 151 and corresponding to the contract monitoring device 101 is registered to the storage unit 34.

Further, regardless of whether the monitoring device 101 is a contract monitoring device, the management device 171 may be configured to transmit warning information to the terminal device 151 corresponding to the monitoring device 101.

Further, the management device 171 may be configured not to transmit warning information.

Further, a configuration may be employed in which an external device on the external network 161 other than the management device 171 may transmit warning information to the terminal device 151. In this case, in a case where, for example, post-process information that includes identification information of the contract monitoring device 101 indicates the possibility of a malfunction occurring in the vehicle 1 within a predetermined period, the management unit 33 of the management device 171 transmits the post-process information and transmission destination information indicating identification information of the terminal device 151 corresponding to the contract monitoring device 101 to the external device via the communication unit 31.

The external device receives the post-process information and the transmission destination information transmitted from the management device 171 and transmits warning information indicating the content of the post-process information to the terminal device 151 indicated by the transmission destination information.

<Flow of Operations>

Each device in the vehicle malfunction prediction system 201 includes a computer, and an arithmetic processing unit, such as a CPU, of the computer reads from a memory not illustrated and executes a program that includes some or all of the steps in a sequence chart described below. The program of each of the plurality of devices can be externally installed. The program of each of the plurality of devices is stored in a recording medium and distributed.

[Prediction of Malfunction in Vehicle]

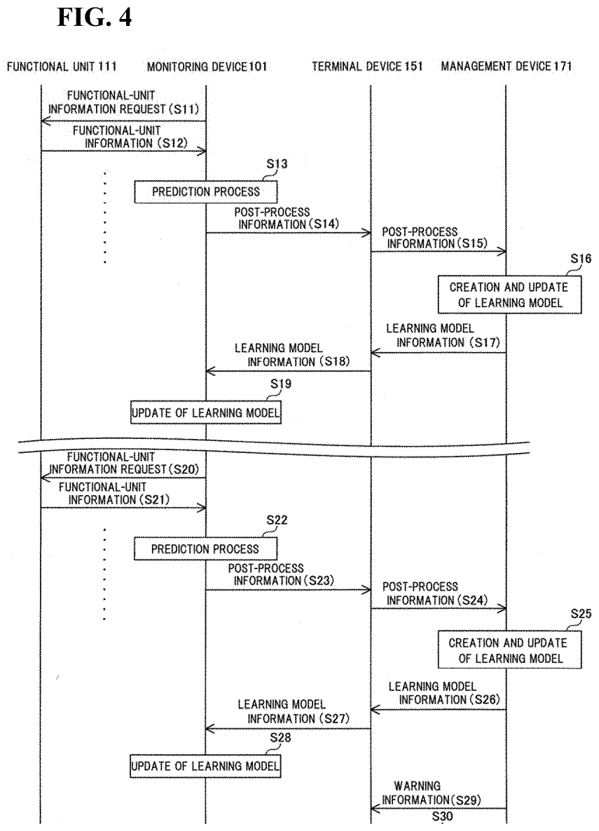

FIG. 4 is a sequence chart illustrating an example flow of operations of devices related to a prediction process in the vehicle malfunction prediction system according to the embodiment of the present invention. FIG. 4 illustrates a flow of operations of one functional unit 111, one monitoring device 101, one terminal device 151, and the management device 171. It is assumed here that the monitoring device 101 already retains a learning model created by the management device 171.

With reference to FIG. 4, first, the monitoring device 101 transmits a functional-unit information request to the functional unit 111 (step S11).

Next, the functional unit 111 receives the functional-unit information request from the monitoring device 101 and transmits functional-unit information to the monitoring device 101 (step S12).

Next, the monitoring device 101 performs a prediction process of predicting a malfunction in the vehicle 1 on the basis of the functional-unit information received from the functional unit 111 and the latest learning model retained by the monitoring device 101 (step S13).

Next, the monitoring device 101 transmits post-process information that indicates the functional-unit information used in the prediction process and the result of the prediction process to the terminal device 151 (step S14).

Next, the terminal device 151 receives the post-process information from the monitoring device 101 and transmits the post-process information to the management device 171 (step S15). The operations from step S11 to step S15 are repeated regularly or irregularly. Accordingly, a plurality of pieces of post-process information are accumulated in the management device 171.

It is assumed here that the latest post-process information received by the management device 171 indicates that a malfunction is less likely to occur in the vehicle 1 or indicates the possibility of a malfunction occurring in the vehicle 1 beyond a predetermined period. In this case, the management device 171 does not create or transmit warning information.

Next, the management device 171 uses the plurality of accumulated pieces of post-process information to create and update a learning model that is used in a prediction process (step S16).

Next, the management device 171 transmits learning model information indicating the latest learning model to the terminal device 151 (step S17).

Next, the terminal device 151 receives the learning model information from the management device 171 and transmits the learning model information to the monitoring device 101 (step S18).

Next, the monitoring device 101 receives the learning model information from the terminal device 151 and updates the learning model retained by the monitoring device 101 with the latest learning model on the basis of the learning model information (step S19). The operations from step S16 to step S19 are repeated regularly or irregularly.

Next, the monitoring device 101 transmits a functional-unit information request to the functional unit 111 (step S20).

Next, the functional unit 111 receives the functional-unit information request from the monitoring device 101 and transmits functional-unit information to the monitoring device 101 (step S21).

Next, the monitoring device 101 performs a prediction process of predicting a malfunction in the vehicle 1 on the basis of the functional-unit information received from the functional unit 111 and the latest learning model indicated by the learning model information transmitted from the management device 171 (step S22).

Next, the monitoring device 101 transmits post-process information that indicates the functional-unit information used in the prediction process and the result of the prediction process to the terminal device 151 (step S23).

Next, the terminal device 151 receives the post-process information from the monitoring device 101 and transmits the post-process information to the management device 171 (step S24).

Next, the management device 171 uses a plurality of accumulated pieces of post-process information to create and update a learning model that is used in a prediction process (step S25).

Next, the management device 171 transmits learning model information indicating the latest learning model to the terminal device 151 (step S26).

Next, the terminal device 151 receives the learning model information from the management device 171 and transmits the learning model information to the monitoring device 101 (step S27).

Next, the monitoring device 101 receives the learning model information from the terminal device 151 and updates the learning model retained by the monitoring device 101 with the latest learning model on the basis of the learning model information (step S28).

Next, it is assumed that the latest post-process information received by the management device 171 indicates the possibility of a malfunction occurring in the vehicle 1 within a predetermined period. Further, it is assumed that the monitoring device 101 that has transmitted the post-process information is a contract monitoring device. In this case, the management device 171 transmits warning information to the terminal device 151 on the basis of the post-process information (step S29).

Next, the terminal device 151 receives the warning information from the management device 171 and, for example, displays the content of the warning information on a screen of the terminal device 151 (step S30).

Note that transmission of warning information by the management device 171 (step S29) and display of the content of the warning information by the terminal device 151 (step S30) may be performed at any timing after transmission of post-process information from the terminal device 151 to the management device 171 (step S24).

Further, the monitoring device 101 may create warning information based on post-process information and transmit the created warning information to the terminal device 151 in place of the management device 171.

[Notification of Conditions of Vehicle]

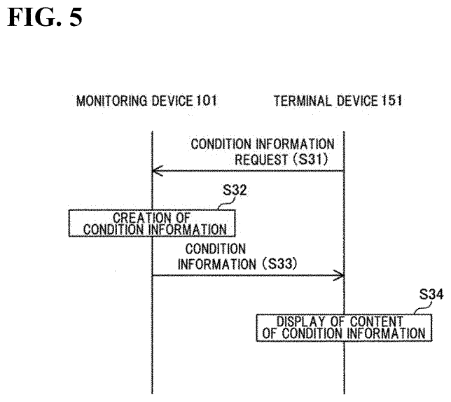

FIG. 5 is a sequence chart illustrating a flow of operations of devices related to transmission of condition information in the vehicle malfunction prediction system according to the embodiment of the present invention.

With reference to FIG. 5, first, the terminal device 151 transmits a condition information request to the monitoring device 101 in accordance with a user operation (step S31).

Next, the monitoring device 101 receives the condition information request from the terminal device 151, refers to a plurality of pieces of post-process information retained by the monitoring device 101, and, for example, creates condition information indicating the result of a prediction process included in the latest post-process information (step S32).

Next, the monitoring device 101 transmits the created condition information to the terminal device 151 (step S33).

Next, the terminal device 151 receives the condition information from the monitoring device 101 and, for example, displays the content of the condition information on a screen of the terminal device 151 (step S34).

Note that transmission of warning information from the management device 171 to the terminal device 151 (step S29 illustrated in FIG. 4) is performed in a case where there is the possibility of a malfunction occurring in the vehicle 1 within a predetermined period. Accordingly, in a case where there is the possibility of a malfunction occurring in the vehicle 1 beyond a predetermined period of, for example, four months, transmission of warning information to the terminal device 151 is not performed.

On the other hand, transmission of condition information from the monitoring device 101 to the terminal device 151 (step S33 illustrated in FIG. 5) is performed in response to reception of a condition information request (step S31 illustrated in FIG. 5) regardless of the possibility of a malfunction occurring in the vehicle 1 and the time when a malfunction is highly likely to occur in the vehicle 1. Accordingly, the user can grasp the conditions of the vehicle 1 in detail.

The technique described in Non Patent Literature 1 can detect abnormalities occurring in vehicles but has difficulty in predicting in advance abnormalities occurring in vehicles.

In the vehicle malfunction prediction system 201 according to an embodiment of the present invention, each monitoring device 101 among the one or more monitoring devices 101 obtains from each functional unit 111 in the vehicle 1 in which the monitoring device 101 is mounted, functional-unit information indicating the result of measurement related to the vehicle 1. The monitoring device 101 transmits the obtained functional-unit information to the management device 171 via the external network 161. The management device 171 creates a learning model based on machine learning on the basis of a plurality of pieces of functional-unit information received from the one or more monitoring devices 101 and transmits the created learning model to the one or more monitoring devices 101. Each monitoring device 101 predicts a malfunction in the vehicle 1 in which the monitoring device 101 is mounted on the basis of new functional-unit information obtained from each functional unit 111 in the vehicle 1 in which the monitoring device 101 is mounted and on the basis of the learning model received from the management device 171.

As described above, with the configuration in which the monitoring device 101 predicts a malfunction in the vehicle 1 on the basis of functional-unit information and a learning model, the user can grasp in advance a malfunction that may occur in the vehicle 1. The management device 171 creates a learning model, and therefore, the configuration of the monitoring device 101 can be made simple. Further, in a case where the management device 171 creates a learning model by using functional-unit information from a plurality of monitoring devices 101, the management device 171 can create a learning model of higher accuracy by using the results of measurement in a plurality of vehicles 1.

Accordingly, in the vehicle malfunction prediction system 201 according to the embodiment of the present invention, a malfunction in the vehicle 1 can be predicted with high accuracy by using a device having a simple configuration.

Further, in the vehicle malfunction prediction system 201 according to the embodiment of the present invention, the monitoring device 101 transmits the result of prediction of a malfunction in the vehicle 1 in which the monitoring device 101 is mounted to the external network 161.

With the above-described configuration, in a case where, for example, the monitoring device 101 transmits the result of prediction of a malfunction in the vehicle 1 to the management device 171, the management device 171 can create a learning model of higher accuracy using the result of prediction by the monitoring device 101.

Further, in the vehicle malfunction prediction system 201 according to the embodiment of the present invention, the monitoring device 101 and the management device 171 transmit and receive information via the terminal device 151 in the vehicle 1 in which the monitoring device 101 is mounted.

With the above-described configuration, the monitoring device 101 need not have a function of communicating with the management device 171 via the external network 161, and therefore, the configuration of the monitoring device 101 can be further made simple.

Further, in the vehicle malfunction prediction system 201 according to the embodiment of the present invention, an external device provided on the external network 161 sends a notification of the result of prediction, by the monitoring device 101, of a malfunction in the vehicle 1 to a terminal device.

With the above-described configuration, a highly convenient system in which a notification of the result of prediction by the monitoring device 101 can be sent to the user owning the terminal device can be implemented.

Further, in the vehicle malfunction prediction system 201 according to the embodiment of the present invention, the external device selectively sends the notification of the result of prediction to a specific terminal device.

With the above-described configuration, for example, a notification of the result of prediction by the monitoring device 101 can be selectively sent to a user who has made in advance a contract with the administrator of the external device, and the administrator can be, for example, paid for the service of sending the notification of the result of prediction.

Further, in the vehicle malfunction prediction system 201 according to the embodiment of the present invention, the monitoring device 101 receives a transmission request for condition information that indicates the conditions of the vehicle 1 in which the monitoring device 101 is mounted and sends a notification of the result of prediction of a malfunction in the vehicle 1 to a transmission source that has transmitted the transmission request.

With the above-described configuration, the user can grasp the conditions of the vehicle 1 at a desired timing regardless of the result of prediction, by the monitoring device 101, of a malfunction in the vehicle 1.

Further, in the monitoring device 101 according to an embodiment of the present invention, the vehicle internal communication unit 11 obtains from each functional unit 111 in the vehicle 1 in which the monitoring device 101 is mounted, functional-unit information indicating the result of measurement related to the vehicle 1. The vehicle external communication unit 14 transmits the functional-unit information obtained by the vehicle internal communication unit 11 to the management device 171. The prediction unit 12 predicts a malfunction in the vehicle 1 on the basis of a learning model based on machine learning, the learning model being created by the management device 171 on the basis of a plurality of pieces of functional-unit information received from one or more monitoring devices 101, and on the basis of new functional-unit information obtained by the vehicle internal communication unit 11.

As described above, with the configuration in which the monitoring device 101 predicts a malfunction in the vehicle 1 on the basis of functional-unit information and a learning model, the user can grasp in advance a malfunction that may occur in the vehicle 1. The management device 171 creates a learning model, and therefore, the configuration of the monitoring device 101 can be made simple. Further, in a case where the management device 171 creates a learning model by using functional-unit information from a plurality of monitoring devices 101, the management device 171 can create a learning model of higher accuracy by using the results of measurement in a plurality of vehicles 1.

Accordingly, with the monitoring device 101 according to the embodiment of the present invention, a malfunction in the vehicle 1 can be predicted with high accuracy by using a device having a simple configuration.

In the vehicle malfunction prediction method according to an embodiment of the present invention, first, each monitoring device 101 obtains from each functional unit 111 in the vehicle 1 in which the monitoring device 101 is mounted, functional-unit information indicating the result of measurement related to the vehicle 1. Next, the monitoring device transmits the obtained functional-unit information to the management device 171 via the external network 161. Next, the management device 171 creates a learning model based on machine learning on the basis of a plurality of pieces of functional-unit information received from one or more monitoring devices 101. Next, the management device 171 transmits the created learning model to the one or more monitoring devices 101. Next, each monitoring device 101 predicts a malfunction in the vehicle 1 in which the monitoring device 101 is mounted on the basis of new functional-unit information obtained from each functional unit 111 in the vehicle 1 in which the monitoring device 101 is mounted and on the basis of the learning model received from the management device 171.

As described above, with the method in which the monitoring device 101 predicts a malfunction in the vehicle 1 on the basis of functional-unit information and a learning model, the user can grasp in advance a malfunction that may occur in the vehicle 1. The management device 171 creates a learning model, and therefore, the configuration of the monitoring device 101 can be made simple. Further, in a case where the management device 171 creates a learning model by using functional-unit information from a plurality of monitoring devices 101, the management device 171 can create a learning model of higher accuracy by using the results of measurement in a plurality of vehicles 1.

Accordingly, with the vehicle malfunction prediction method according to the embodiment of the present invention, a malfunction in the vehicle 1 can be predicted with high accuracy by using a device having a simple configuration.

Further, in the vehicle malfunction prediction method according to an embodiment of the present invention, first, the vehicle internal communication unit 11 obtains from each functional unit 111 in the vehicle 1 in which the monitoring device 101 is mounted, functional-unit information indicating the result of measurement related to the vehicle 1. Next, the vehicle external communication unit 14 transmits the functional-unit information obtained by the vehicle internal communication unit 11 to the management device 171. Next, the prediction unit 12 predicts a malfunction in the vehicle 1 on the basis of a learning model based on machine learning, the learning model being created by the management device 171 on the basis of a plurality of pieces of functional-unit information received from one or more monitoring devices 101, and on the basis of new functional-unit information obtained by the vehicle internal communication unit 11.

As described above, with the method in which the monitoring device 101 predicts a malfunction in the vehicle 1 on the basis of functional-unit information and a learning model, the user can grasp in advance a malfunction that may occur in the vehicle 1. The management device 171 creates a learning model, and therefore, the configuration of the monitoring device 101 can be made simple. Further, in a case where the management device 171 creates a learning model by using functional-unit information from a plurality of monitoring devices 101, the management device 171 can create a learning model of higher accuracy by using the results of measurement in a plurality of vehicles 1.

Accordingly, with the vehicle malfunction prediction method according to the embodiment of the present invention, a malfunction in the vehicle 1 can be predicted with high accuracy by using a device having a simple configuration.

The above-described embodiments should be considered to be illustrative in all aspects and not restrictive. The scope of the present invention is indicated not by the description given above but by the appended claims and is intended to include all changes within the meaning and scope of equivalence of the appended claims.

The above description includes features additionally stated below.

[Additional Statement 1]

A vehicle malfunction prediction system including:

one or more monitoring devices, each monitoring device among the one or more monitoring devices obtaining from a functional unit in a vehicle corresponding to the monitoring device, functional-unit information indicating a result of measurement related to the vehicle; and

a management device, in which

the monitoring device transmits the obtained functional-unit information to the management device via an external network,

the management device creates a learning model based on machine learning on the basis of a plurality of pieces of functional-unit information received from the one or more monitoring devices and transmits the created learning model to the one or more monitoring devices,

each monitoring device predicts a malfunction in the vehicle corresponding to the monitoring device on the basis of new functional-unit information obtained from the functional unit in the vehicle corresponding to the monitoring device and on the basis of the learning model received from the management device,

the functional unit makes a diagnosis as to whether a malfunction is occurring in the functional unit or another device connected to the functional unit and transmits the functional-unit information further indicating a result of the diagnosis to the monitoring device, and

the monitoring device is provided in the vehicle and predicts a malfunction in the vehicle on the basis of a time-series change in the result of measurement indicated by the functional-unit information and on the basis of the learning model.

[Additional Statement 2]

A monitoring device including:

an obtaining unit that obtains from a functional unit in a vehicle, functional-unit information indicating a result of measurement related to the vehicle;

a transmission unit that transmits the functional-unit information obtained by the obtaining unit to a management device; and

a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit, in which

the monitoring device is provided in the vehicle,

the functional unit makes a diagnosis as to whether a malfunction is occurring in the functional unit or another device connected to the functional unit and transmits the functional-unit information further indicating a result of the diagnosis to the monitoring device,

the prediction unit predicts a malfunction in the vehicle on the basis of a time-series change in the result of measurement indicated by the functional-unit information and on the basis of the learning model, and

the prediction unit is capable of sending a notification of a result of prediction of a malfunction in the vehicle to a terminal device.

### REFERENCE SIGNS LIST

1 vehicle
11 vehicle internal communication unit (obtaining unit)
12 prediction unit
13 storage unit
14 vehicle external communication unit (transmission unit)
31 communication unit
32 model creation unit
33 management unit
34 storage unit
101 monitoring device
111 functional unit
131 CAN bus
132 connector
151 terminal device
161 external network
171 management device (external device)
201 vehicle malfunction prediction system

1. A vehicle malfunction prediction system comprising:
one or more monitoring devices, each monitoring device among the one or more monitoring devices obtaining from a functional unit in a vehicle in which the monitoring device is mounted, functional-unit information indicating a result of measurement related to the vehicle; and
a management device, wherein
the monitoring device transmits the obtained functional-unit information to the management device via an external network,
the management device creates a learning model based on machine learning on the basis of a plurality of pieces of functional-unit information received from the one or more monitoring devices and transmits the created learning model to the one or more monitoring devices, and
each monitoring device predicts a malfunction in the vehicle in which the monitoring device is mounted on the basis of new functional-unit information obtained from the functional unit in the vehicle in which the monitoring device is mounted and on the basis of the learning model received from the management device.

2. The vehicle malfunction prediction system according to claim 1, wherein the monitoring device transmits a result of prediction of a malfunction in the vehicle in which the monitoring device is mounted to the external network.

3. The vehicle malfunction prediction system according to claim 1, wherein the monitoring device and the management device transmit and receive information via a terminal device in the vehicle in which the monitoring device is mounted.

4. The vehicle malfunction prediction system according to claim 1, further comprising
an external device that is provided on the external network and sends a notification of a result of prediction, by the monitoring device, of a malfunction in the vehicle to a terminal device.

5. The vehicle malfunction prediction system according to claim 4, wherein the external device selectively sends the notification of the result of prediction to a specific terminal device.

6. The vehicle malfunction prediction system according to claim 1, wherein the monitoring device receives a transmission request for condition information that indicates a condition of the vehicle in which the monitoring device is mounted and sends a notification of a result of prediction of a malfunction in the vehicle to a transmission source that has transmitted the transmission request.

7. A monitoring device comprising:
an obtaining unit that obtains from a functional unit in a vehicle in which the monitoring device is mounted, functional-unit information indicating a result of measurement related to the vehicle;
a transmission unit that transmits the functional-unit information obtained by the obtaining unit to a management device; and
a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.

8. (canceled)

9. A vehicle malfunction prediction method for a monitoring device, the vehicle malfunction prediction method comprising:
a step of obtaining from a functional unit in a vehicle in which the monitoring device is mounted, functional-unit information indicating a result of measurement related to the vehicle;
a step of transmitting the obtained functional-unit information to a management device; and
a step of predicting a malfunction in the vehicle on the basis of a learning model based on machine learning, the learning model being created by the management device on the basis of a plurality of pieces of functional-unit information received from one or more monitoring devices, and on the basis of obtained new functional-unit information.

10. A non-transitory computer-readable recording medium storing a vehicle malfunction prediction program to be used in a monitoring device, the vehicle malfunction prediction program causing a computer to function as:
an obtaining unit that obtains from a functional unit in a vehicle in which the monitoring device is mounted, functional-unit information indicating a result of measurement related to the vehicle;
a transmission unit that transmits the functional-unit information obtained by the obtaining unit to a management device; and
a prediction unit that predicts a malfunction in the vehicle on the basis of a learning model based on machine learning, the learning model being created by the management device on the basis of a plurality of pieces of functional-unit information received from one or more monitoring devices, and on the basis of new functional-unit information obtained by the obtaining unit.
